(19) United States
(12) Patent Application Publication
(10) Pub. No.: US 2006/0252532 A1
(43) Pub. Date: Nov. 9, 2006

(54) Multi-player reaction time game systems and methods

(75) Inventor: Charles M. Stovall, Ramona, CA (US)

Correspondence Address: PILLSBURY WINTHROP SHAW PITTMAN LLP, P.O. BOX 10500, MCLEAN, VA, 22102, US

(73) Assignee: HSW, Inc., Ramona, CA (US)

(21) Appl. No.: 11/331,580

(22) Filed: Jan. 13, 2006

Related U.S. Application Data
(60) Provisional application No. 60/643,965, filed on Jan. 13, 2005.

(51) Int. Cl. A63F 13/00

(52) U.S. Cl. 463/30; 463/36

(57) ABSTRACT

An electronic reaction timer game device is disclosed that may be used in a game of skill by a solitary player or by a team of players. Plural games are disclosed that include best-time and head-to-head competitions and tournaments. The invention provides an improved electronic reaction timer game that controls the interaction among one or more participants, between individual participants and the game device and between multiple participants and the game device. Game devices are disclosed that can generate automatic sequences of events and stimuli to prompt response by one or more participants. System and methods are disclosed that enable measurement and display of reaction times. Embodiments of the invention provide tournament games employing the game device. System and methods are disclosed for hosting tournaments. Team, family and individual tournament games are disclosed. Systems and methods of hosting tournament games are disclosed.

### CROSS-REFERENCE TO RELATED APPLICATIONS

This application claims the benefit of U.S. Provisional Application Ser. No. 60/643,965, filed Jan. 13, 2005, which provisional application is incorporated by reference or all purposes.

### BACKGROUND OF THE INVENTION

### Description of Related Art

Man's interest in determining or knowing “Who is the Fastest?” goes back to before the Olympics. With the advent of microprocessors, there have been a large number of games capable of being played by one or more players, and in which the microprocessor causes the generation of an action and the player attempts to respond to this action. However no games have been developed that are based on the measurement of more than one player's reaction time. Further, no game has been developed that is scalable such that a single player can compete alone with a game-piece that can be used to compete in a competition with large numbers of competitors.

### BRIEF SUMMARY OF THE INVENTION

The present invention provides a reaction timer that may be used in a game of skill by a solitary player or by a team. Players may compete to beat a best time and may compete in a competitive “head-to-head” competition or tournament. The invention provides an improved electronic reaction timer game that controls the interaction between one or more participants, or which can be played against the machine itself.

The invention also provides an electronic reaction timer game that measures and displays reaction times measured in milliseconds (for example) of one or more participants against the machine. The invention also provides an electronic reaction timer game device that provides an automatic sequence of events that must be responded to by one or more participants.

Further, the invention provide an electronic reaction timer game device that provides a pseudo-random time duration not known to one or more participants thus providing a reaction time game that reduces the possibility that participants may anticipate or estimate the occurrence of triggering stimuli.

The invention provides microcontroller controlled electronic reaction timer game that controls the progress of a game played between one or more participants. The microcontroller controlled electronic reaction timer game can be programmed to play a variety of games.

The games typically comprise the generation of a sequence of perceptible events or stimuli, measuring time elapsed between the events or stimuli and the receipt of a response by a participant. One or more result times may be displayed, recorded and transmitted to a central database for determining a game winner.

Embodiments of the invention also provide for a Tournament game of reaction time employing the reaction timer. For purposes of the present invention, a Tournament game of reaction time measurement and averaging is defined as three distinct games played in the qualifying and playoff rounds.

The first game is the ‘Singles’ game where a player enters their age into the computer and the computer queries it's local database to find the ‘Singles’ best score in that age group. That score is displayed indicating the average score the player must achieve to win. The player plays five rounds with scores in units of milliseconds or sub milliseconds and the results are averaged and compared against the score to win to determine the outcome of the game. If the player wins the computer records the new winning scores in it's local database and remote database and prints a lottery type printout which contains the scores and average of the five rounds as well as the location, date, time, local host generated unique number, the current tournament global prize and local prize.

The second game is the ‘Family’ game where a family will enter the number of players into the computer and the computer queries its local database to find the best score in that size of family. That score is displayed indicating the average score the family must achieve to win. The family plays five rounds in one minute with scores in units of milliseconds or sub milliseconds and the results are averaged and compared against the score to win to determine the outcome of the game. If the family wins the computer records the new winning scores in its local database and remote database and prints a lottery type printout which contains the scores and average of the five rounds as well as the location, date, time, local host generated unique number, the current tournament global prize and local prize.

The third game is the ‘Team’ game where a team will enter the number of players into the computer and the computer queries its local database to find the ‘Team’ best score for the team of that number of players. That score is displayed indicating the average score the team must achieve to win. The team plays five rounds with scores in units of milliseconds or sub milliseconds and the results are averaged and compared against the score to win to determine the outcome of the game. If the team wins the local host records the new winning scores in it's local database and remote database and prints a lottery type printout which contains the scores and average of the five rounds as well as the location, date, time, local host generated unique number, the current tournament global prize and local prize.

Unlike prior Tournaments, the present invention is a Tournament that requires no prior preparation physically or mentally, that there is little or no chance of injury, that takes very little time, is totally fair and yet challenging. Since there is only one axis of spatial movement of one finger responding to a ‘GO’ indicator only the bodily capacity of speed is involved in this Tournament.

The Tournament game of reaction time measurement and averaging can be played over an electronic system, such as a local area network (LAN), wide area network (WAN), campus-wide network, fixed based unit network, Intranet or Internet.

### BRIEF DESCRIPTION OF THE DRAWINGS

These and other aspects of an embodiment of the present invention are better understood by reading the following detailed description of the preferred embodiment, taken in conjunction with the accompanying drawings, in which:

FIG. 1 is a perspective view of a first exemplary embodiment of the invention;

FIG. 2 is a block diagram of the first exemplary embodiment of the invention;

FIG. 3 is a detailed schematic diagram of the first exemplary embodiment of the invention;

FIG. 4 is a perspective view of a second exemplary embodiment of the invention;

FIG. 5 is a block diagram of the electrical components of the second exemplary embodiment of the invention;

FIG. 6 is a detailed schematic diagram of the electronic circuitry of the second exemplary embodiment of the invention;

FIG. 7 is a perspective view of a third exemplary embodiment of the invention;

FIG. 8 is a block diagram of the electrical components of the third exemplary embodiment of the invention;

FIG. 9 is a detailed schematic diagram of the electronic circuitry of the third exemplary embodiment of the invention;

FIGS. 10-20 are logical flow charts illustrating the functions performed in exemplary embodiments of the invention.

FIG. 21 is a flowchart illustrating a Tournament game of reaction time as provided in some embodiments of the invention; and

FIG. 22 shows an example results sheet.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention. Where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

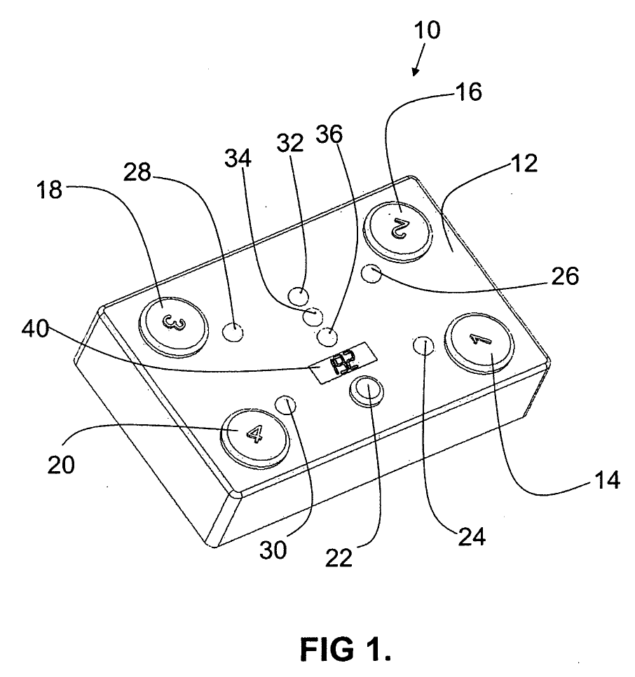

Referring to FIG. 1, an exemplary embodiment of the invention is provided in perspective view. A reaction timer, generally indicated at 10, typically comprises a housing 12, a plurality of push-button switches, a plurality of indicators and a display 40. The housing 12 typically encloses control circuits, batteries and other components of the reaction timer 10. In some embodiments, the dimensions of the reaction timer 10 are similar to those of a credit card. In other embodiments, a table top version of the reaction timer 10 may be used that typically provides access to a larger number of concurrent users (hereinafter “participants”) and, in at least some embodiments, enhanced functionality.

In the exemplary embodiment, the plurality of push-button switches includes four participant switches 14, 16, 18 and 20 that are operated by one or more participants. The plurality of push-button switches provides a means for participants to respond to stimuli and any appropriate form of switch, transducer, pressure sensor, motion detector or other input device or system may be substituted for one or more of the plurality push-button switches. The plurality of push-button switches also includes one or more control switches that receive commands from the one or more participants for selecting operating modes the reaction timer 10 such as type of game, game activation, game end, results display and device reset.

The plurality of indicators typically includes participant indicators 24, 26, 28 and 30 and control indicators 32, 34, 36. The plurality of indicators typically is implemented using LEDs, incandescent and other lamps, electroluminescent displays, LCD displays and any appropriate system for providing visual cues. In some embodiments, other stimuli or combinations of stimuli may be used including, for example, audible signals, pressure and electrical signals. In the exemplary embodiment, the participant indicators are typically implemented as LED lamps and are used to prompt each of the four participants to activate an associated participant switch during active games. The participant indicator may also be used to associate information provided by the display 40 with one of the four participants or to provide other indications associated with the four participants including, for example, location of participants involved in a current game.

The plurality of indicators may also include game indicators 32, 34 and 36 for controlling the flow of games. Typically, the game indicators include a READY 32, a SET 34 and a GO 36 indicator. It will be appreciated that the use and meaning of these and other game indicators may be defined differently by various games implemented in embodiments of the invention.

The display 40 is typically used to communicate various information, the information including game results, game information, average scores, highest scores measured over a series of games. It will be appreciated that, for reaction time games, scores are typically displayed as millisecond values but may equally be displayed as a number related to a standard reaction time. In some embodiments, the display may be used for displaying information unrelated to games, such as time of day, date, timer and text messages. Any suitable display device may be used, including LED, LCD, electroluminescent, plasma and CRT displays.

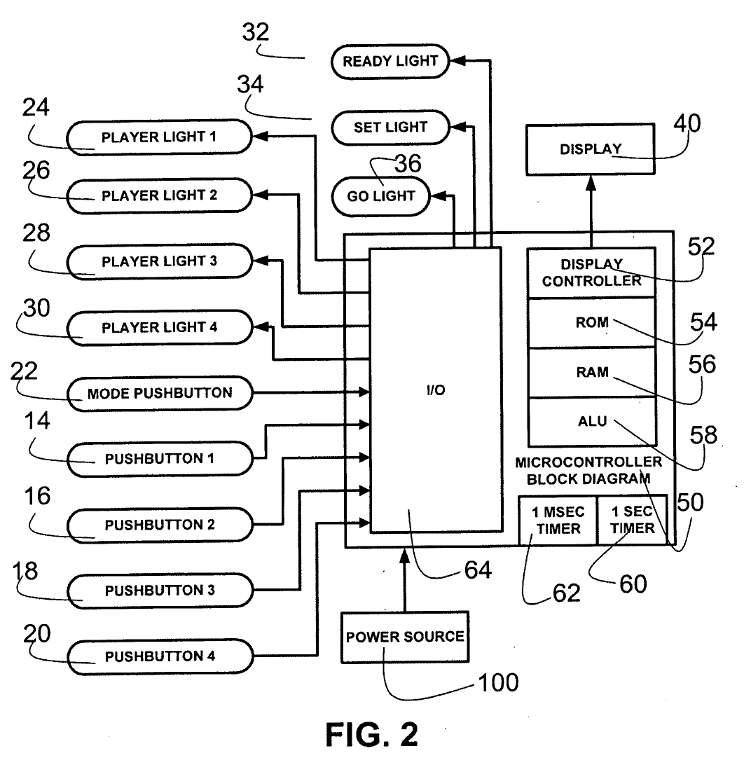

Now referring also to FIG. 2, a block diagram of the exemplary reaction timer is shown. In this embodiment, a single controlling device 50 typically comprises an Input-Output (“I/O”) component 64, a processor 58, a read-only memory (“ROM”) 54, a random-access memory (“RAM”) 56, a display controller 52 and a plurality of timers 60 and 62. The controlling device 50 is typically powered by an electrical power source 100, such as a battery. For the purpose of illustration, the exemplary reaction timer is depicted as having a single controlling device 58 but it will be appreciated that two or more controlling devices may be used in some embodiments. In these latter embodiments, the two or more controlling devices 50 typically share processing loads such that, for example, large numbers of participants can be accommodated without of timing accuracy. In at least some embodiments, additional controlling devices may be used to handle communications activities.

Continuing with the exemplary embodiment of FIGS. 1 and 2, the I/O 64 is typically connected to the plurality of push-button switches and the plurality of indicators. The I/O typically receives input from the plurality of switches indicating a current position for each switch. The I/O may also provide outputs that determine the state of each of the plurality of indicators as either on or off. In some embodiments, the indicators may have more than two states, additional states including a plurality of intensity levels and a plurality of alternative colors. The I/O is typically controlled by the processor 58 that executes software maintained in the ROM 54. The software controls the operation of the reaction timer. The ROM may also include operating rules defining a plurality of games to be played using the reaction timer and may further include information used to identify the device for the purpose of communications.

By way of example, when one of the plurality of games is selected, typically by use of the MODE switch 22, the processor 58 executes software associated with the selected game and uses associated game-specific parameters, metrics and other information stored in the ROM. The processor 58 typically provides stimuli using the plurality of indicators, initiates one of the plurality of timers 60 and 62, receives notification when a participant activates one of the plurality of participant switches. The processor 58 subsequently calculates results associated with the time delay between the stimuli and the activation of the participant switch. The results are tabulated in RAM 56 according to the operating rules of the selected game. The processor 58 may also provide responses to participants using the plurality of indicators.

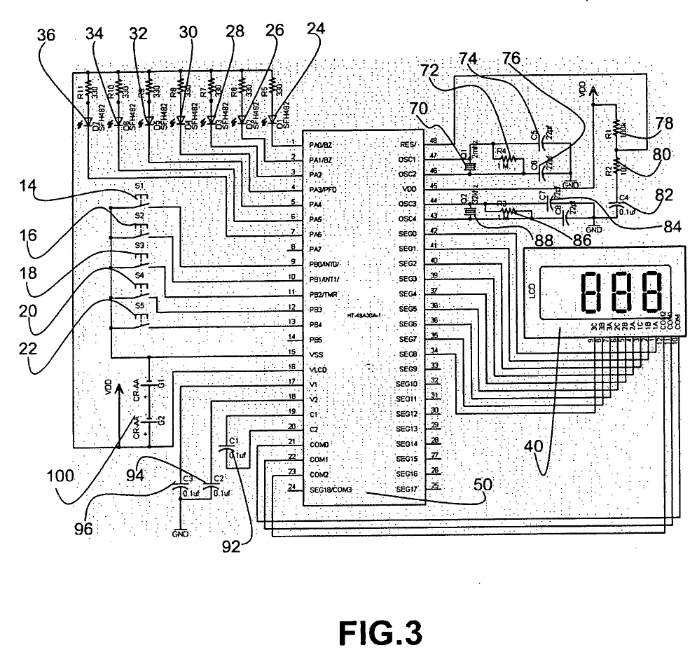

FIG. 3 depicts a schematic drawing of an embodiment of the invention that implements the exemplary reaction timer 10 of FIG. 1. A Holtek Semiconductor HT49R50A-1 single chip microcontroller 50 manufactured by Holtek Semiconductor, Inc. is connected to a power supply 100. A timing circuit comprising a capacitor 82 and resistors 78 and 80 controls the proper startup operation of the microcontroller 50. A 2 MHz crystal or resonator 70 and an appropriate resistor-capacitor bias circuit 72, 74 and 76 are connected to the microcontroller's first oscillator circuit for the high speed timing. A 32 KHz crystal 88 and an appropriate resistor-capacitor bias circuit 86 and 84 are connected to the microcontroller's second oscillator circuit for the one second timer. Although the exemplary embodiment generates timing signals using circuits constructed from discrete components, it will be appreciated that oscillators may be substituted to provided timing signals in the system. The microcontroller utilizes capacitors 92, 94 and 96 for a voltage pump for the display 40. The microcontroller 50 monitors the state of the play pushbuttons 14, 16, 18 and 20 and the MODE pushbutton 22 by sequentially monitoring its inputs PB0, PB1, PB2, PB3 and PB4. The microcontroller serves to drive the player lights 24, 26, 28, 30 and the “READY” light 32, the “SET” light 34 and the “GO” light 36. The microcontroller 50 has a built-in display controller which is used to drive the display 40.

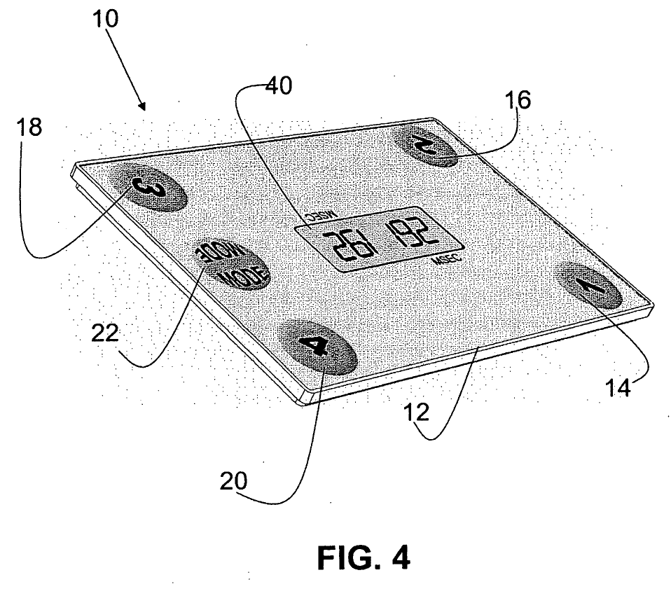

Referring now to FIG. 4, a perspective view of another exemplary embodiment of the reaction timer 10 according to the present invention is provided. The reaction timer 10 comprises a housing 12 a plurality of push-button switches and a display 40. The plurality of push-button switches includes four participant switches 14, 16, 18 and 20 and a MODE switch 22. The four participant switches may be concurrently operated by one or more players of a game. The MODE switch 22 is typically used to control selection of game to be played and to start an instance of the selected game.

In this embodiment a six digit display 40 provides a first set of proximately located digits 401 and a second set of proximately located digits 402. The first and second set of digits 401, 402 typically render the same information except that the first set of digits 410 may be read in a first direction 403 and the second set of digits may be read in a second direction 404. The first and second directions may be aligned in a common plane such that the second direction 404 is rotated 180 degrees from the first direction 403. Thus, information may be legibly displayed to participants positioned on two opposite sides of the reaction timer 10. In this exemplary embodiment a six digit display 40 is provided such that the first and second sets of digits 401 and 402 each include three digits.

It will be appreciated that participants may receive stimuli and prompts in the form of numerical information provided by the display 40. For example, participants may be identified by sequential numbering such as players 1-4. Thus, to display a game result of “123” milliseconds for player 3, a number “3” may be first displayed followed by the result “123.” Likewise, control indicators 32, 34 and 36 (see FIG. 1) may be replaced in this exemplary embodiment by a sequence of numbers on each of the two sets of digits 401, 402 such that, for example, a “1” provides a “READY” indicator, a “2” provides a “SET” indicator and a “3” provides a “GO” indicator.

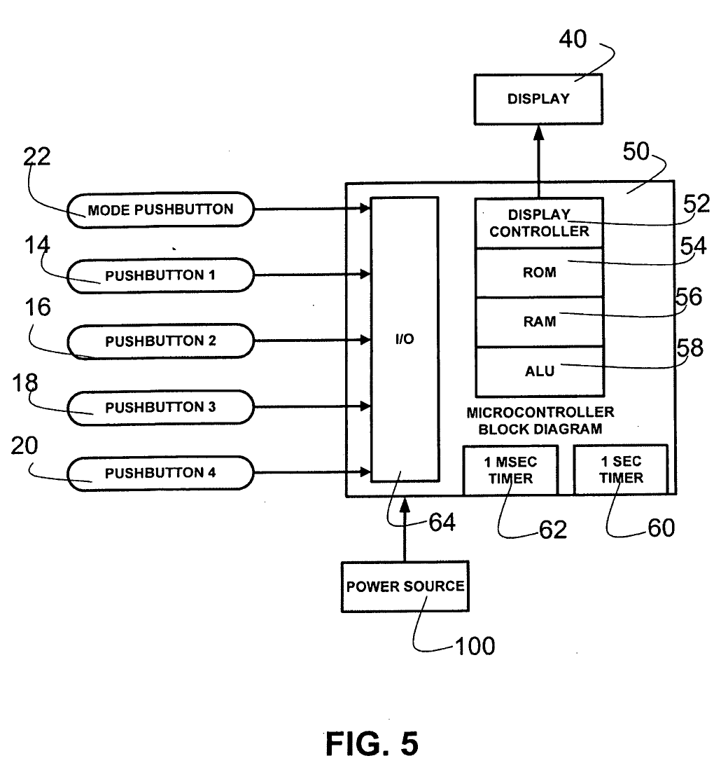

Now referring also to FIG. 5, a block diagram of the exemplary reaction timer of FIG. 4 is shown. In this embodiment, a single controlling device 50 typically comprises an I/O component 64, a processor 58, a ROM 54, a RAM 56, a display controller 52 and a plurality of timers 60 and 62. The controlling device 50 is typically powered by an electrical power source 100, such as a battery. For the purpose of illustration, the exemplary reaction timer is depicted as having a single controlling device 58 but it will be appreciated that two or more controlling devices may be used in some embodiments. In these embodiments, the two or more controlling devices 50 typically share processing loads such that, for example, large numbers of participants can be accommodated without of timing accuracy. In at least some embodiments, additional controlling devices may be used to handle communications activities.

Continuing with the exemplary embodiment of FIGS. 4 and 5, the I/O 64 is typically connected to the plurality of push-button switches. The I/O typically receives input from the plurality of push-button switches indicating a current position for each switch. The I/O may be controlled by the processor 58 which executes software maintained in the ROM 54. The software controls the operation of the reaction timer. The ROM may also include operating rules for a plurality of games to be played using the reaction timer and may further include information used to identify the device for the purpose of communications.

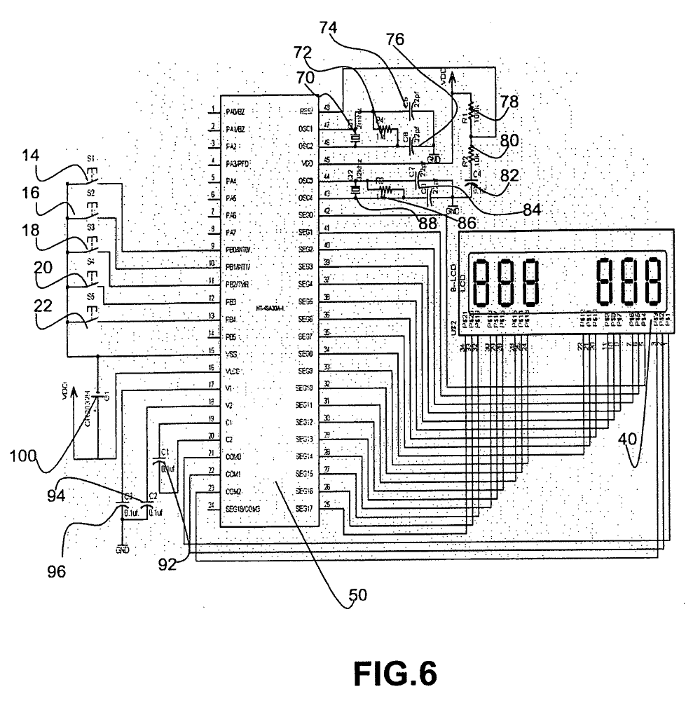

FIG. 6 provides a schematic of an embodiment of the invention that implements the exemplary reaction timer 10 of FIG. 4. A Holtek Semiconductor HT49R50A-1 single chip microcontroller manufactured by Holtek Semiconductor, Inc. is suitable for use as the microcontroller 50. A power supply 100 is connected to the microcontroller 50. A timing circuit comprising a capacitor 82 and resistors 78 and 80 controls the proper startup operation of the microcontroller 50. A 2 MHz crystal or resonator 70 and a appropriate resistor-capacitor bias circuit 72, 74 and 76 are connected to the microcontroller's first oscillator circuit for the high speed timing which the one millisecond utilizes. A 32 Khz crystal 88 and a appropriate resistor-capacitor bias circuit 86, and 84 are connected to the microcontroller's second oscillator circuit for the low speed timing. The microcontroller utilizes capacitors 92, 94 and 96 for a voltage pump for the display 40. The microcontroller 50 monitors the state of the play pushbuttons 14, 16, 18 and 20 and the MODE pushbutton 22 by sequentially monitoring its inputs PB0, PB1, PB2, PB3 and PB4. Game control start and game selection is implemented using the MODE pushbutton switch 22 connected to microcontroller 50. A display controller 52 is used to drive the six digits of display 40.

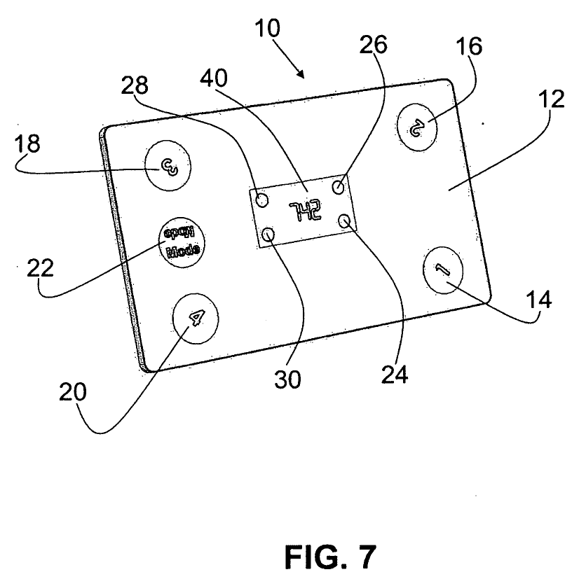

FIG. 7 provides a perspective view of yet another exemplary embodiment of the reaction timer 10 according to the present invention. In this exemplary embodiment, the reaction timer 10 comprises a housing 12, a plurality of push-button switches, a plurality of indicators and a display 40. The housing 12 typically encloses control circuits, batteries and other components of the reaction timer 10. In this embodiment, the plurality of push-button switches includes four participant switches 14, 16, 18 and 20 that are operated by one or more participants and the plurality of indicators includes participant indicators 24, 26, 28 and 30.

In this embodiment, the plurality of participant indicators is embedded in the display 40 such that each of the plurality of participant indicators 24, 26, 28 and 30 may be readily identified with an associated one of the four participant switches 14, 16, 18 and 20. Thus the participant indicators may be used to prompt each of the four participants to activate an associated participant switch during active games. The participant indicator may also be used to associate information provided by the display 40 with one of the four participants or to provide other indications associated with the four participants including, for example, location of participants involved in a current game. Thus information provided by the display 40 may be associated with a specific participant by activating the closest of the participant indicators 24, 26, 28, 30.

The display 40 is typically used to display various information, the information including game results, game information, average scores, highest scores measured over a series of games. In many embodiments, the display 40 may rotate the displayed information through 180 degrees as required for easy viewing by all participants.

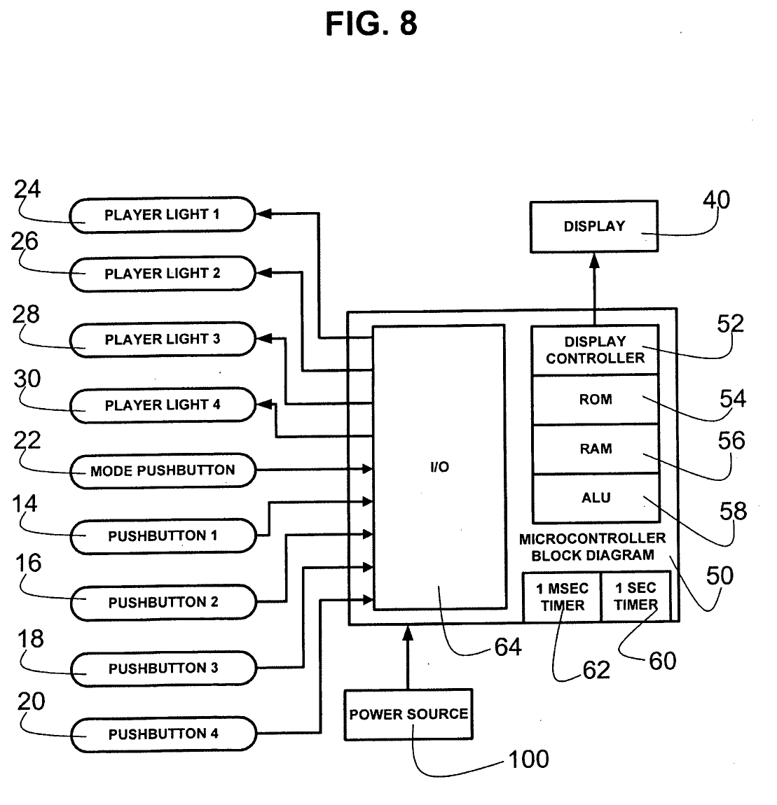

Now referring also to FIG. 8, a block diagram of the exemplary reaction timer of FIG. 7 is shown. In this embodiment, a single controlling device 50 typically comprises an I/O component 64, a processor 58, a ROM 54, a RAM 56, a display controller 52 and a plurality of timers 60 and 62. The controlling device 50 is typically powered by an electrical power source 100, such as a battery.

Continuing with the exemplary embodiment of FIGS. 7 and 8, the I/O 64 is typically connected to the plurality of push-button switches and the plurality of participant indicators. The I/O typically receives input from the plurality of push-button switches indicating a current position for each switch. The I/O is typically controlled by the processor 58 that executes software maintained in the ROM 54. The software controls the operation of the reaction timer. The ROM may also include operating rules for a plurality of games to be played using the reaction timer and may further include information used to identify the device for the purpose of communications.

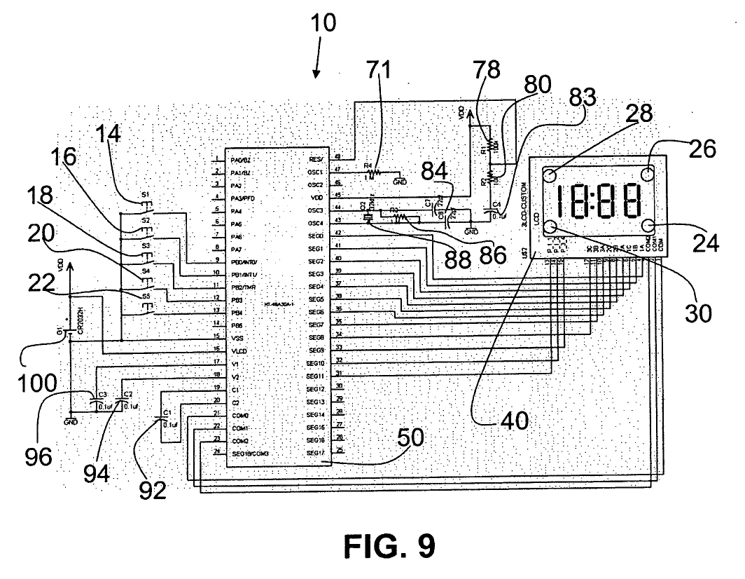

FIG. 9 provides a schematic of an embodiment of the invention that implements the exemplary reaction timer 10 of FIG. 7. A Holtek Semiconductor HT49R50A-1 single chip microcontroller manufactured by Holtek Semiconductor, Inc. is suitable for use as the microcontroller 50. A power supply 100 is connected to the microcontroller 50. A timing circuit comprising a capacitor 82 and resistors 78 and 80 controls the proper startup operation of the microcontroller 50. It will be appreciated that the use of a 1% 241 kohm resistor 71 connected to the microcontroller's first oscillator circuit for high speed timing provides a reduction in cost of manufacture. It will be appreciated that the value of the resistor is selected to provide an equivalent operating frequency as that provided using a 2 Mhz crystal or resonator. It will be appreciated that the use of a an internal resistor-capacitor network located inside the microcontroller can be utilized to generate the microcontroller's second oscillator; the use of such network may offer reductions in manufacturing cost but can lead to less accurate low speed timing. It will be appreciated that the frequency is selected by the microcontroller's configuration register to provide an equivalent operating frequency as that provided using a 32 Khz crystal or resonator. A 32 Khz crystal 88 and an appropriate resistor-capacitor bias circuit 86 and 84 are connected to the microcontroller's second oscillator circuit to provide a low speed, one-second timer. The microcontroller typically utilizes capacitors 92, 94 and 96 to implement a voltage pump for the display 40. The microcontroller 50 monitors the state of the participant switches 14, 16, 18 and 20 and the MODE switch 22 by sequentially monitoring inputs PB0, PB1, PB2, PB3 and PB4. Game control and game selection may be implemented using the MODE switch 22 connected to the microcontroller 50.

In this latter embodiment, four participant indicators 24, 26, 28 and 30 are typically associated with the participant switches 14, 16, 18 and 20. The display controller 52 may be used to drive the 3 1/2 digits of display 40 for rendering participant scores in milliseconds and time of day as desired.

Flowchart Description

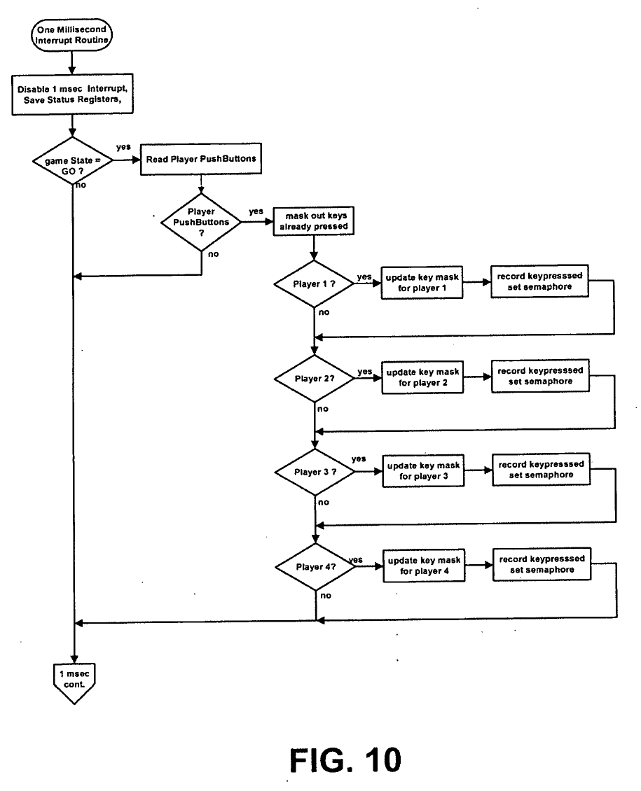

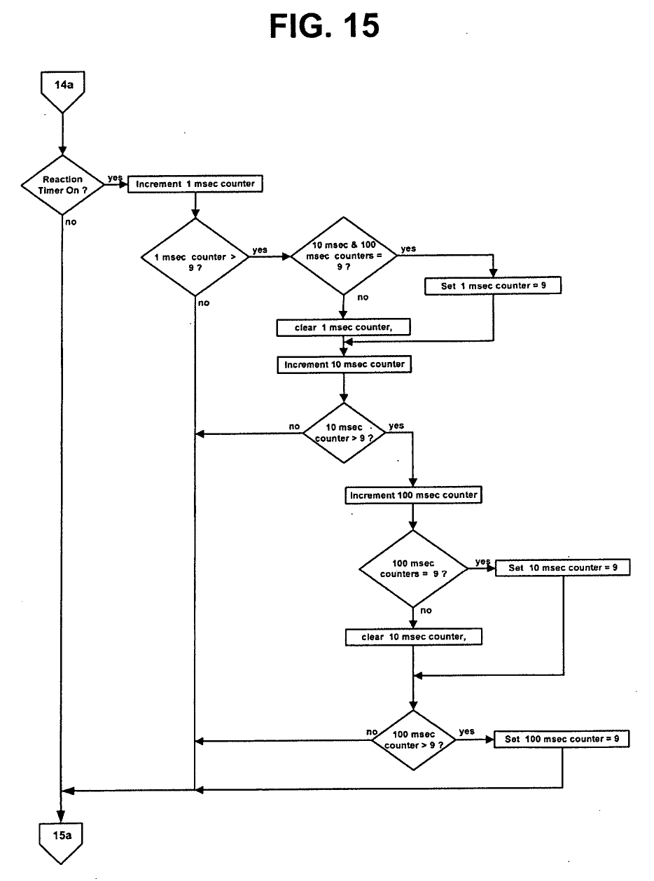

The operation of various games as implemented in at least some embodiments of the invention will be better understood by reference to the flowcharts provided in FIGS. 10-19.

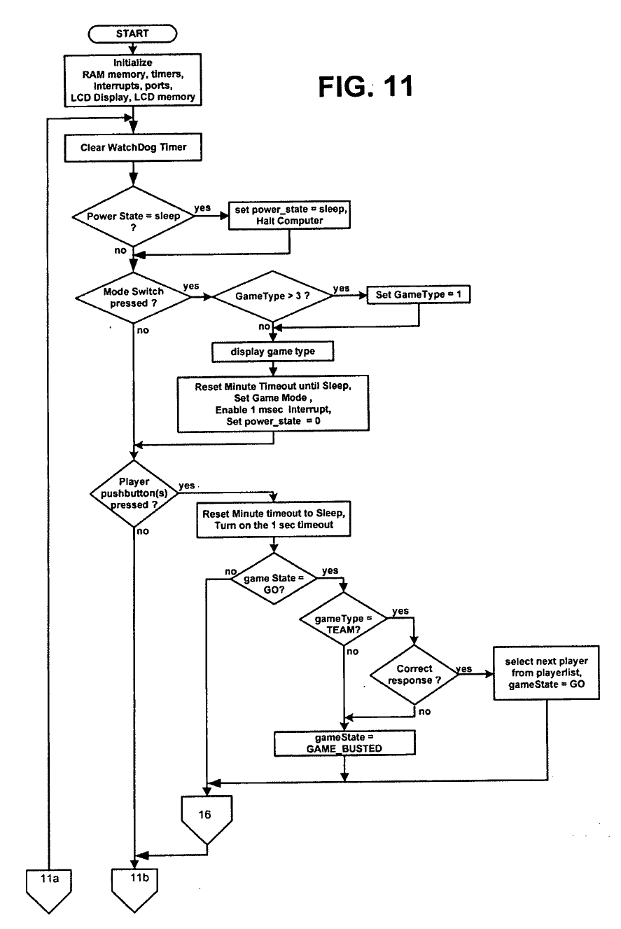

The flowcharts in FIG. 10 and FIG. 11 with reference also to FIG. 2, illustrate the operation of a main program loop in embodiments of the invention. At step 1000, the reaction timer is started and the processor 58 initializes various components including I/O 64, RAM 56, display controller 52 and timers 60 and 62. Optionally, a watchdog timer may be reset at step 1002 wherein the watchdog timer is a hardware device well understood in the software art as a means to restore normal operation when a processor is rendered inoperative through software or hardware malfunction. At steps 1004, the desired state of operation of the system is determined. If the system is in “HALT mode,” operation is halted at step 1006 to conserve power and the device next awakens upon receiving a one second interrupt from a timer 60. Sleep mode typically entails disabling a main high-speed system clock that controls timing within the processor 58. If “HALT mode” is not set, or the one second interrupt is received, the MODE switch 22 may be tested at step 1008.

If the MODE switch 22 has been pressed then, at steps 1010, 1012, 1014 and 1016, the desired state of operation will be set to normal mode and a game type will be selected. Selection of game type is typically performed by monitoring the MODE switch 22 position until no change is detected for a selected minimum period of time. For each activation of the MODE switch 22, the selected game type is changed to a next in a sequence game types. The sequence of game types is cyclically repeated until MODE switch 22 activity ceases. When the game type is selected, the state of operation is modified to game mode and the game may start and a timed preparation sequence is initiated to indicate, for example, the sequence of “READY, SET and GO.” Following the preparation sequence, the state of operation is typically set to GO mode. In many embodiments of the invention, the timing of the preparation sequence may include fixed or random time intervals as determined by the selected game type.

At step 1018, the state of the plurality of participant switches is tested. If a participant switch is activated, the system state is tested for “GO mode” at step 1022. If “GO mode” is not set, a false start is determined and corrective action is taken beginning at step 1600. Additionally, steps 1022, 1024, 1026, 1028 and 1038 describe the process for handling a team game as described in more detail below. In many embodiments, the process for handling games has common characteristics, including providing stimuli during a preparation sequence, providing a test stimulus to one or more participants, receiving a response from the one or more participants, verifying the validity of the response and measuring a time between the provision of the test stimulus and the receipt of a valid response as the reaction time of at least one of the one or more participants. The stimuli, as described above, may include a visual stimulus but may also include audible and tactile stimuli.

Turning now to FIG. 11, embodiments of the system provide a HALT mode during which power is conserved. When the reaction timer is inactive, a timer causes the system to become at least temporarily active at step 1106 after a predetermined period that is typically no longer than one second. During this period of activity a plurality of maintenance tasks may be performed at step 1118 including, for example, initializing timer, resetting watchdog timers, updating system state and returning to HALT state.

In at least some embodiments, a real time clock function is provided that may replace or augment the HALT mode. The real time clock function, shown at steps 1112 and 1114 is used to perform as a timepiece showing, for example, time of day and date. If display mode is available at step 1110, clock display and maintenance functions may be enabled after a period of reaction timer inactivity.

In many embodiments, the reaction timer generates random or pseudo-random numbers at step 1116. In some embodiments, the random number is provided by reading a free-running high speed counter at every pass through the main loop.

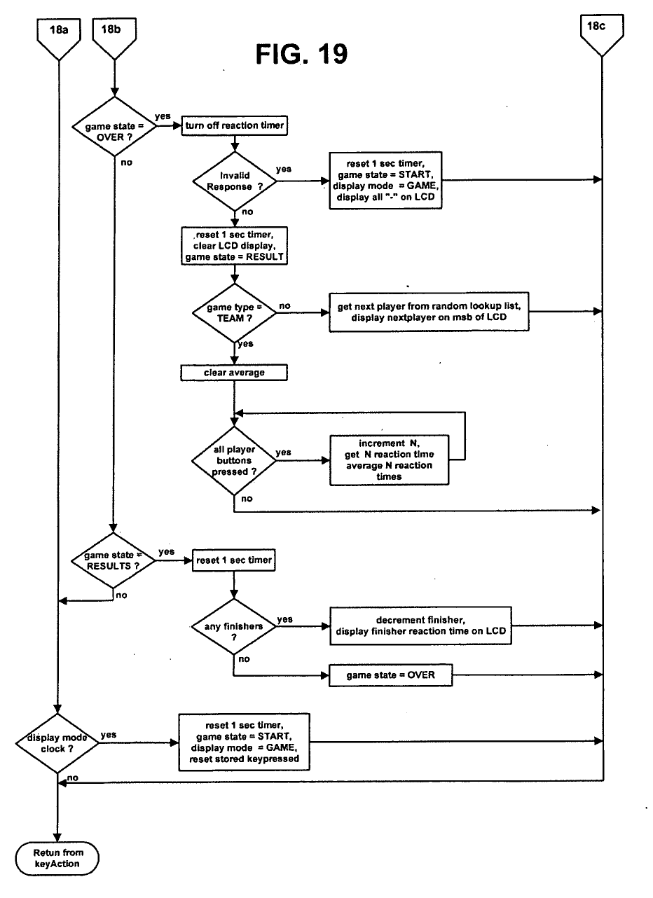

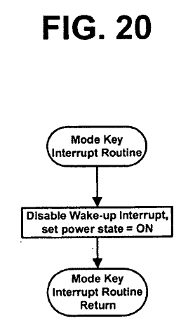

Referring now to FIG. 19 together with FIG. 2, in many embodiments, the MODE key operates to provide a “wake-up” facility. While in HALT mode, many embodiments of the invention slow or stop a system clock to minimize power usage. In these embodiments, it is typical that power is drawn only for maintaining volatile memory such as the content of RAM 56, current state, such as program counter, stack, and other processor registers. Additionally, timers are typically maintained in operation to provide a wakeup signal at selected intervals. Generally, wakeup intervals of approximately one second duration may be sufficient for an embodiment that is used solely as a game device. However, it will be appreciated that in some embodiments the reaction timer may perform other functions including a timepiece, an identification device, a credit card, a smart card and a radio frequency identification (“RFID”). In these latter embodiments, it may be necessary to decrease or eliminate the selected intervals between the wakeup signals.

The processor 58 is typically programmed to immediately wake-up out of HALT mode if the MODE key 22 is activated. In many embodiments, the activation of the MODE key 22 invokes a MODE Key Interrupt routine at step 1900. At step 1902, the routine sets the Power State variable which in the main loop may enable a high speed clock. As described above, the reaction timer typically operates in HALT mode when by a timeout timer occurs indicating that, for example, no participant keys were activated for a selected period of time. The latter period of time is typically of the order of one or more minutes.

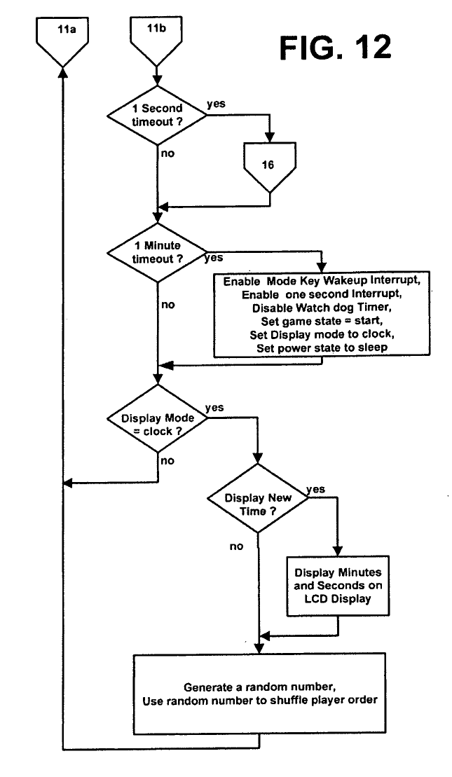

FIG. 12 shows the one second interrupt service routine used to monitor the MODE switch 22 and update the one second and one minute timeout timers used for game control and sleep mode control. The one second interrupt routine is shown in FIG. 12. During the one second timer interrupt routine, if the MODE switch 22 is pressed then the game type is rendered on display 40 and the rendered display increments each second until the switch is released when the desired game type is selected. Two games are described below; however, the microprocessor (described in a subsequent portion of the specification) may be programmed to play other games.

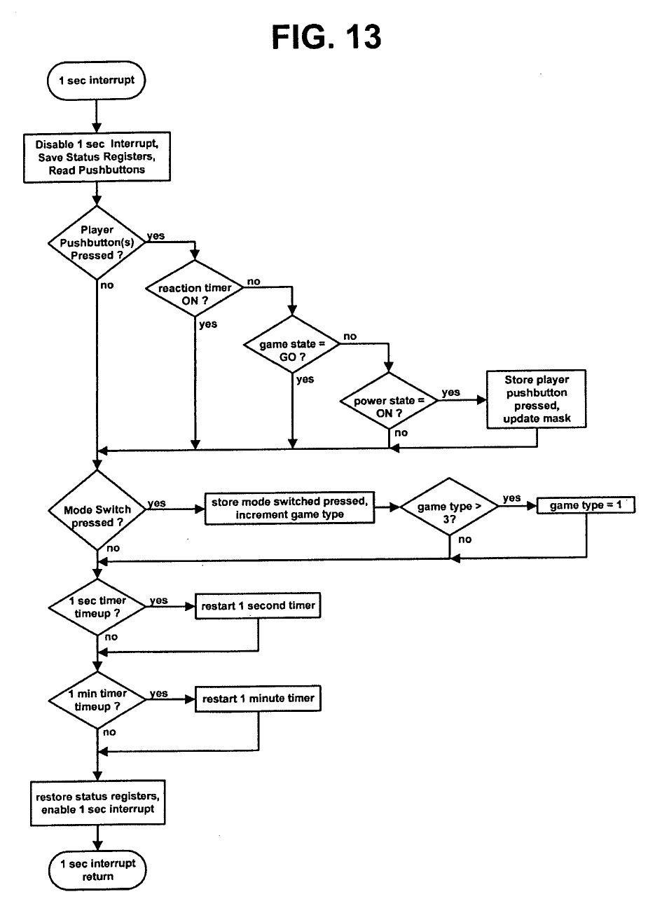

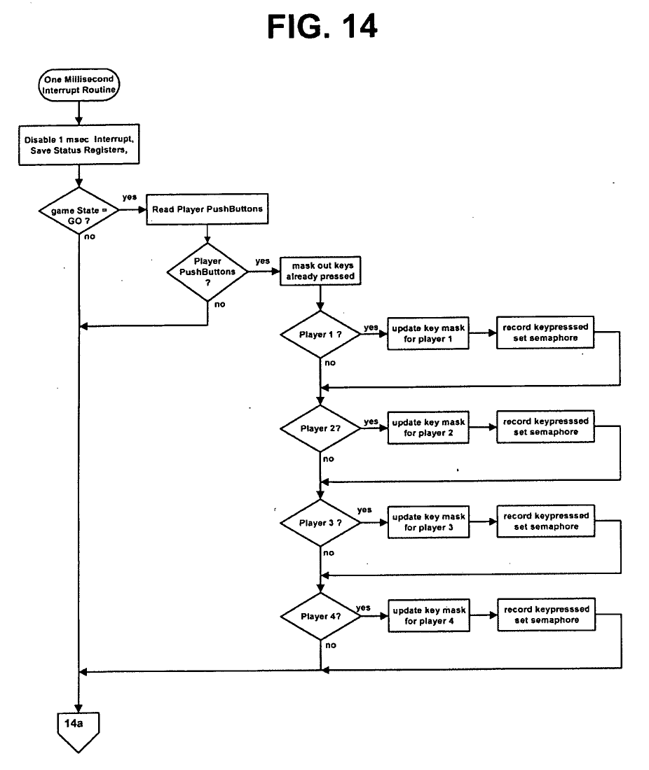

Referring now to FIGS. 2, 13, 14 and 15 the flowcharts of FIGS. 13, 14 an 15 describe the operation of an exemplary program that may be used in some embodiments to provide timing functions used to generate game results. It will be appreciated that the timing function are implemented according to capabilities and limitations of the microcontroller 50 and its associated components. In the example provided, an interrupt service routine provides timing intervals of milliseconds and fractions of milliseconds. Starting at step 1300 in FIG. 13, a game timer interrupt service routine (“ISR”) prevents duplicate interrupts by temporarily disabled at step 1302; the interrupts are enabled upon completion of the ISR. If, at step 1304, a current game is in progress, the plurality of participant keys are read at step 1306 and tested for change at step 1308. If change is detected, keys previously activated in the current game are ignored at step 1310 and a timestamp records a result time for each of the plurality of participant keys 14, 16, 18 and 20 that is newly activated. Thus steps 1312, 1314 and 1316 operate to test (step 1312), flag as activated (step 1314) and record the time (step 1316) for a first participant key 14. Likewise, a second participant key is processed at steps 1322, 1324 and 1326 and so on. Thus, valid result times and invalid participant responses may be recorded during the current game.

Having processed game activity, the game timer ISR processes game time information beginning at step 1400 in FIG. 14. In the exemplary embodiment, a game timer is typically initialized to zero and enabled when the current game begins. If the game timer is enabled at step 1402, a current game time is maintained by incrementing one or more counters for each execution of the ISR. Thus, by controlling the frequency of the ISR, the resolution of the game timer may be determined. In the example shown in FIG. 14, the frequency of the ISR is selected as 1 KHz providing resolution of one millisecond. It will be appreciated that the resolution of the game timer can be adjusted as required by modifying the ISR frequency. Further in the example, decade counters are implemented to provide a timer capable of counting several seconds. It will be appreciated that the game timer may provide the delay between stimuli provided at the start of the current game until any participant key is activated.

In at least some embodiments, a timer similar to the game timer may be implemented to provide real time information used for a timepiece function. In other embodiments the game timer may be modified to operate as real time clock providing both timepiece and game timing capabilities. In yet other embodiments, one or more timer functions may be implemented using a real time clock component fabricated as part of the microcontroller 50 or as an external component (not shown).

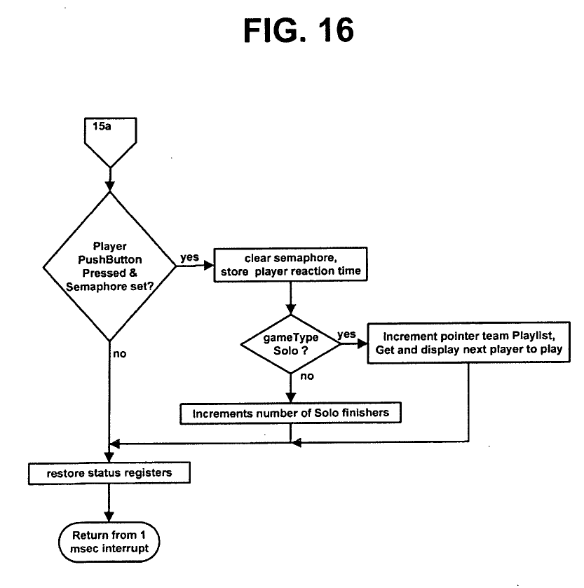

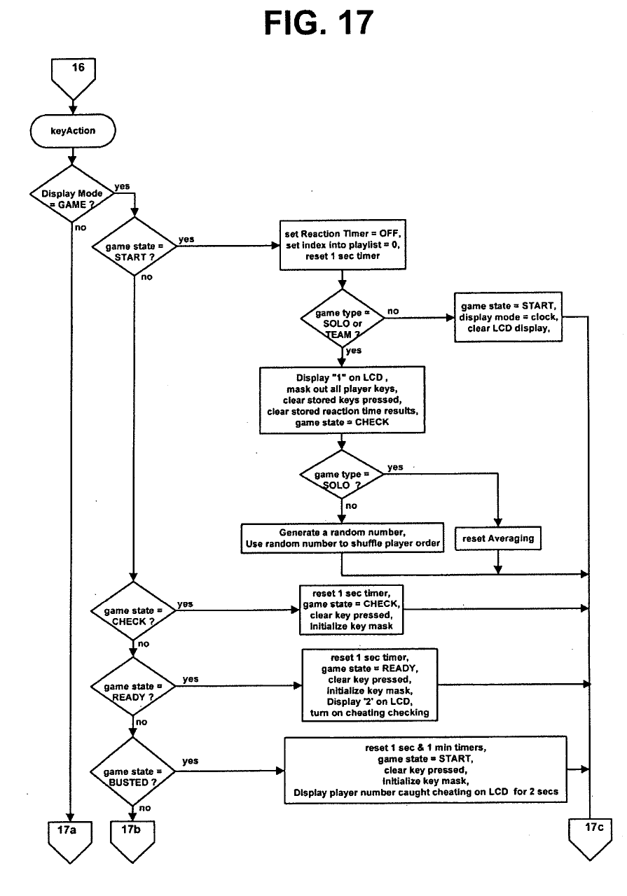

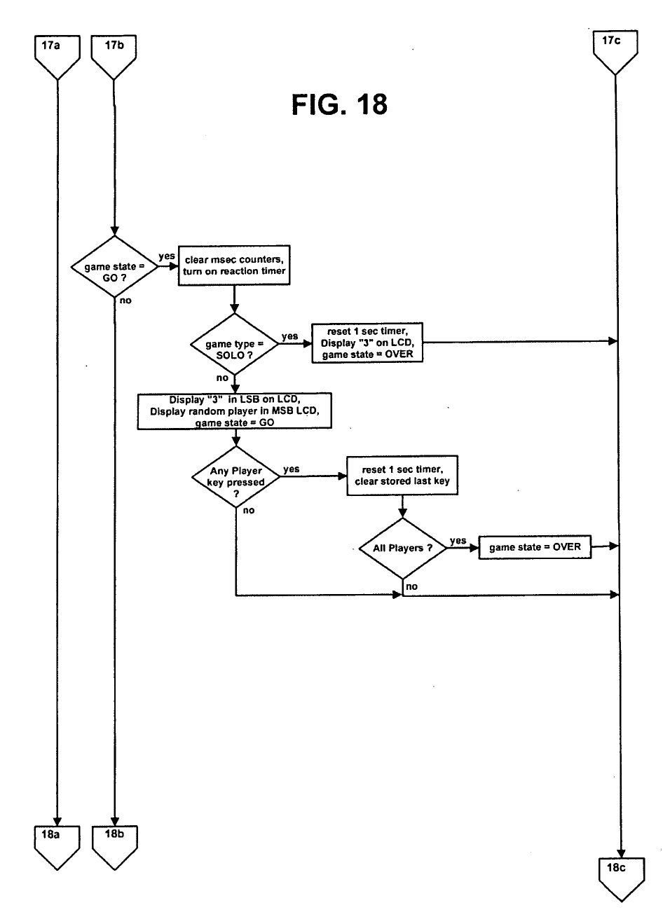

FIG. 16, FIG. 17 and FIG. 18 provide flowcharts of exemplary software routines that may be used to implement one or more games that may be played on embodiments of the reaction timer. It will be appreciated by reviewing the flowcharts that the implementation may be varied according to the capabilities of the microcontroller 50 (see FIG. 2). In the example provided, a keyaction routine operates using a game state that changes as a game progresses. The keyaction routine also modifies mode operation based on game type that describes the type of game being played. Thus, for example, in a basic game, keyaction causes stimuli to be provided to all participants and receives all subsequent participant key activations as valid actions, recording the time delay between stimulus and an a first activation for every participant key. The keyaction routine may then order all measured time delays such that the least time delay is designated as a winning reaction time. Results can then be displayed by notifying each participant in turn of the participant's measured reaction time. Game descriptions are provided below.

Typically, if a participant activates a participant key and the game state indicates that the activation is not valid (for example, game state is not “GO”), then an error may be recorded and an error message is rendered to the display 40 for a short time. In some embodiments, the game may be forfeit while in other embodiments, the game may be restarted.

It will be appreciated that where an embodiment provides multiple game playing options, the keyaction routine may provide a menu to select a type of game to be played. In the exemplary embodiment shown FIG. 1, the menu may be implemented in its most simple form by providing a sequential list of options in response to MODE key 32 activations. Thus, a participant begins a game by activating the MODE key 22 to “wake-up” the reaction timer 10 and uses subsequent MODE key activations to scroll through a list of available games. When selection is complete, the participant may activate another key to start a game or wait for the game to begin after a predetermined delay.

For the purposes of illustration, several game types will be described. Each of the game types is described to highlight aspects of the invention and it will be appreciated that variations and combinations of game types are possible and anticipated in the present invention. Further, embodiments of the invention provide scalability to permit large numbers of participants to play a game. In these embodiments, the reaction timer may be connected to a network to provide results to a control center. In at least some inventions, game play is synchronized using commonly available networking techniques such that players may be located at geographically diverse locations while playing in a timed common game.

It will also be appreciated that some embodiments of the invention employ stimuli other than visible indicators to control flow of games. For example, audible signals may substitute for the indicators, providing tonal or verbal cues to participants. Some embodiments may provide electrical and electromechanical actuators for providing tactile cues to participants. Examples of tactile cues include Braille devices and customized game pads. Thus although the present invention may be used primarily in competitions, some embodiments of the invention may be used for therapy of various kinds.

Referring again to FIG. 1, a first exemplary game, known hereinafter as the “SOLO” game, starts with a “READY” indicator 32 being turned on or displaying a “1” character in the display 40 depending on the embodiment for a short time. No participant keys are checked during this time. Next the “READY” 32 indicator is turned off and the “SET” 34 indicator is turned on for a random number of seconds or the “1” is changed to a “2” depending on the embodiment for a random number of seconds and the participant keys are checked during this random time for cheating.

If a participant key is pressed prematurely, then a player indicator associated with the participant key is turned on for a short time indicating which participant was guilty of cheating and the game starts over. If no participant cheats then after the random number of seconds the “SET” 34 indicator is turned off and the “GO” 36 indicator is turned on for a short time; alternatively the “2” in the display 40 is changed to a “3” for a short time, according to the capabilities of the embodiment. The participants may then press then their respective participant keys and their reaction times are recorded. The participant with the fastest reaction time is indicated as the winner by display of the winning score and the appropriate participant indicator.

The winning participant's indicator or participant number is typically rendered to the display for a short time followed by their score in milliseconds for a short time depending on the embodiment. The next fastest participant's indicator may then have be turned on for a short time and the next fastest score displayed for a short time. This display sequence may continue for all participants or for a selected number of participants.

A second game, hereinafter the “TEAM” game, begins in a manner similar to that of the SOLO game, in that the reaction timer turns off indicators before enabling the READY indicator 32; in some embodiments, a “1” is displayed in the display 40. After a short fixed time, the READY indicator 32 is disabled and the SET indicator 34 is enabled; the display 40 may change to a indicate a “2” in some embodiments. The SET state remains for a short random time after which the SET indicator 34 is disabled and the GO indicator 36 is enabled; some embodiments provide a “3” indication in the display 40. The reaction timer then selects participants in a pseudo-random sequence such that one participant is selected at a time. Pseudo-randomness is typically provided by the pseudo-random number generator discussed above. A participant indicator 24, 26, 28 and 30 indicates which participant should activate a participant key. Only the selected participant's participant key is considered valid. Should another participant key be activated, the current game is ended and an ERROR message is displayed for a short time on the display 40 before the game is restarted. If the valid participant key is activated then a reaction time is recorded for the selected participant. It will be appreciated that the timer for measuring reaction time is initialized whenever a participant selection is made and indicated. The game continues until all participants have been selected and recorded a time. If any selected participant does not activate the appropriate participant key, a “NO-TIME” indicator will be recorded indicating

The above games have been given by way of example only, and the number of possible games is limited only by the capability of the microprocessor within the device and the ingenuity of the programmer. The number of games that may be played is considerably greater than the two examples given.

In many embodiments of the invention, the reaction timer is adapted to communicate with various devices including other reaction timers, reaction game access points, transactional systems and network gateways. The reaction timer may communicate using technologies including infrared, USB, wireless networking, cellular communications, Bluetooth and by physical connection. Additionally, the reaction timer may include a wireless transponder that uniquely identifies the reaction timer to a suitable monitoring device.

In some embodiments, a first reaction timer communicates with one or more other reaction timers such that a common contest may be held between the reaction timers. Thus, the communication effectively permits a larger number of participants to engage in a single game. In at least some embodiments, each reaction timer may be provided with a number of tokens that can be used as prizes in games involving multiple reaction timers. In such embodiments, a winning reaction timer that produces a fastest reaction time may receive prize tokens from a defeated reaction timer that produces one or more lesser response times. Reaction timers may accumulate tokens that, in some embodiments, may be redeemed for awards including discounted goods and services. In other embodiments, a predetermined number of accumulated tokens may entitle the holder of a reaction timer to entry in a regional, national or worldwide reaction time competition.

In many embodiments, the reaction timer may be distributed as part of a promotion. For example, a restaurant may provide customers with reaction timers as part of a marketing campaign to promote return visits to the restaurant. In this exemplary embodiment, the customers may be awarded products and services for accumulating a predetermined quantity of tokens. Additionally, the customers may add one or more tokens to their reaction timers with each purchase at the restaurant. Further, customers may be selected to represent one or more stores in a competition spanning all restaurants in a franchise network or within a corporation. In these embodiments, the reaction timer communicates with reaction game access points provided at a restaurant. The access points perform a plurality of functions including identifying reaction timers, receiving updated token counts from reaction timers, notifying restaurant operator and reaction time holders of qualification for awards, transmitting additional tokens to reaction timers and connecting one or more proximately located reaction timers to a network of other reaction timers such that a common game may be played.

In some embodiments of the invention, identifying information is included in the reaction timer that permits the reaction timer to operate as a transactional tool such as a credit card, a smart card and RFID. In these embodiments, the reaction timer is typically issued by a bank or commercial enterprise that maintains an account for the reaction timer user. The reaction timer may be used to identify the user to, for example, a vending machine, an ATM and store checkouts. Purchases, cash withdrawals, cash deposits, product returns and other transactions can be automatically recorded on the user's account. As discussed above, the card issuer may provide the reaction timer for reasons that include ongoing promotional activities, to encourage use of the card and in joint marketing activities with other commercial enterprises to provide a mutually beneficial customer activity.

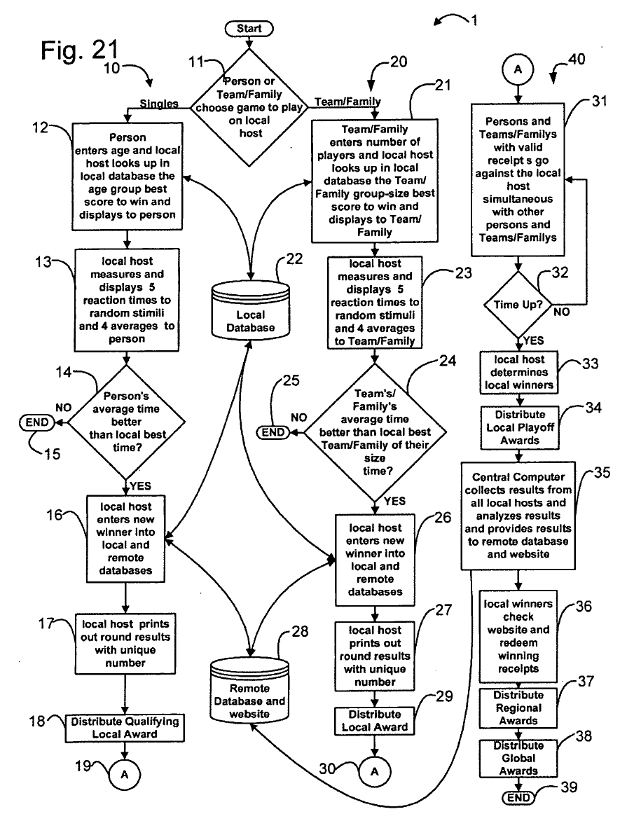

Referring now to FIG. 21, examples of games that may be used in commercial promotions will be described. In some embodiments of the present invention, a method directed toward a Tournament game of reaction time measurement and averaging 1 having a qualifying round 10, 20 and a playoff round 40 is provided. In a Singles game, at least one player participates in the qualifying round 10 against a local host. In at least some embodiments, the local host is accessed at a commercial establishment such as a restaurant. Similarly, two to more players in a Team/Family game may participate in a qualifying round 20 against a local host.

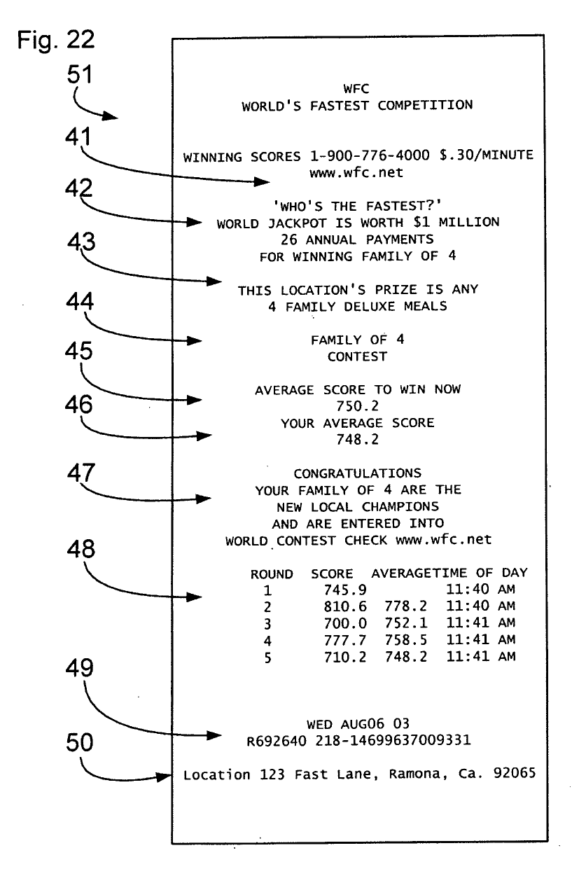

A game commences when one or more persons decide at step 2111 to play a Singles game at step 2110 or a Team/Family game at step 2120. When the Singles game is chosen, the one or more persons enter age information at step 2112 and the local host obtains information related to a best-fit age group at step 2222, including “best score to win.” The local host may display the information obtained as desired. The local host typically measures and displays five reaction times to random stimuli for each of the one or more persons and may calculate average scores for each of the one or more persons and average scores for all of the participating one or more persons. Averages can be calculated using methods including statistical averaging and weighted averaging. Results may then be displayed at 2213. At steps 2214 or 2224, the results, including average times, may be compared to prior best times recorded on a local database according to categories that include age. If the results are an improvement over the prior best times, then the results may be recorded in the data base at steps 2216 and 2226 and a results sheet is printed at step 2217 and 2227 for the one or more persons. An example of a results sheet is provided in FIG. 22. The results sheet for a round may be used to redeem a local award at 2218 and 2229.

Referring now to FIG. 2, an example of the round results sheet is provided. A phone number and website 2241 may be identified for accessing a consolidated list of winning scores. Also typically included is a current jackpot value for a particular tournament 2242, a current location prize 2243, a current type of tournament 2244, an average score required to win 2245 and the average score 2246 obtained by the one or more persons. The results sheet may also include notification that the one or more persons are the local champions and are entered into the next world contest 2247, the one or more persons scores 2248, a current date and unique number 2249 and an address of location where a qualifying round is to be played 2250.

Referring again to FIG. 21, in various embodiments, qualifying Singles and Team/Families may enter into a local playoff at step 2140. Singles and Teams/Families with valid receipts from the prior qualifying rounds (see steps 2110 and 2120) compete against other winners in the same manner as described above but are typically obliged to finish within a predetermined time frame at step 2132. The local host may determine local winners at step 2133 and the location distributes local playoff awards at step 2134. A central computer typically collects results from all local hosts databases, analyzes results and provides ranking to remote database at step 2128 and website at step 2135. Local winners may check website to see if their respective scores qualify them for further awards at step 2136. Winners may take a winning receipt at step 2151 to local location as indicated in FIG. 22 at 2250 for redemption at steps 2137 and 2138. Thus, the end of the playoff round is reached at step 2139.

Typically the qualifying round (As shown at steps 2110 and 2120) is played in a continuous manner. A player typically selects a day and time for participation in the playoff provided the playoff round is active at the selected time. An example of this is illustrated as follows: The tournament is open for qualifying round play from Monday at noon to Saturday at midnight. Any player would have the ability to participate in the qualifying round at the time of his choice, as long as it participation occurs between the pre-established time frames.

The playoff round (as shown at 2140) may begin at a preset time with those players who have qualified by a specific cut-off date and time playing the game of skill against the local host computer. The playoff round may continue for a preset amount of time, as shown in step 2132. After the playoff round has concluded, the results are analyzed to determine the each player's rank according to the lowest average time at step 2133. The central computer typically collects the playoff round results from all local host databases and analyzes the results and may provide the ranking results to the remote database and the tournament website 2134. Local playoff winners may receive a printed receipt displaying achieved scores as in steps 2117 and 2127. The local winners may check the tournament website for further awards 35. An award can then be distributed to those players having winning receipts at steps 2136 and 2137. The tournament then ends as shown in step 2139.

An example of an embodiment of a tournament is set forth below. The parameters of the example are for illustrative purposes only. They are not intended to limit the scope of the invention. The Tournament game of reaction time measurement and averaging is set as Family of four. The tournament may be played with the local host connected over the Internet to a remote host database computer, where the remote host computer and participants' local host are each in different locations. The qualifying round is typically open for play seven days a week, twenty-four hours per day. The playoff round is typically played on each Saturday from 6 p.m. to 8 p.m. GMT. The playoff qualifying cutoff date and time is typically Saturday at noon, GMT.

The Tournament has the following categories shown in Table 1, below.

TABLE 1
GAME

| Single | ages groups |
|---|---|
| | 1-9 |
| | 10-19 |
| | 20-29 |
| | 30-39 |
| | 40-49 |
| | 50-59 |
| | 60-69 |
| | 70-79 |
| | 80-89 |
| | 90-99 |
| Family | Number of family members competing |
| | 2 |
| | 3 |
| | 4 |
| | 5 |
| | 6 |
| | 7 |
| | 8 |
| Team | Number of team members competing |
| | 2 |
| | 3 |
| | 4 |
| | 5 |
| | 6 |
| | 7 |
| | 8 |

Since the tournament is played over the Internet, each player is typically able to participate at a variety of locations at the time of their choosing prior to noon on Saturday.

Although the present invention has been particularly described with reference to embodiments thereof, it should be readily apparent to those of ordinary skill in the art that changes and modifications in the form and details thereof may be made without departing from the spirit and scope of the invention. For example, those skilled in the art will understand that variations can be made in the number and arrangement of components illustrated in the above block diagrams. Additionally, other functions may be added to improve operation of the devices. For example, some embodiments may employ security devices and software to prevent alteration of equipment used in competition. Another example is the addition of clock synchronization functions used to calibrate timing clocks used in the competition. It is intended that the appended claims include such changes and modifications.

What is claimed is:

1. A reaction timer, comprising:
one or more indicators for providing stimuli to at least one participant;
one or more actuators for receiving input from the at least one participant responsive to the stimuli;
a timer for measuring an elapsed time, the elapsed time being an interval of time extending from the provision of the stimuli until the received input from the at least one participant;
a display for communicating the elapsed time to at least one participant; and
a results recorder for maintaining a history of elapsed times for the at least one participant.

2. A method for conducting a reaction time game, comprising:
measuring reaction times of a plurality of participants;
processing the reaction times to generate a result, the result including a listing of participants ordered according to reaction time;
identifying a fastest participant based on the result; and
communicating the result and the identification to the plurality of participants.

3. A method for promoting business activities in a commercial enterprise, comprising:
providing a plurality of customers with one or more reaction timer game piece, the one or more game pieces adapted to record fastest responses to a plurality of stimuli;
receiving results from the one or more game pieces, the results being related to the recorded fastest responses; and
providing awards based on the results.

4. An electronic game for recording fastest response times to a plurality of stimuli.
